(19) United States
(12) Patent Application Publication
(10) Pub. No.: US 2024/0416933 A1
(43) Pub. Date: Dec. 19, 2024

(54) SYSTEM AND METHOD FOR SOFT UNDERSTANDINGS OF AUTOMATED DECISIONS

(71) Applicant: GM GLOBAL TECHNOLOGY OPERATIONS LLC, Detroit, MI (US)

(72) Inventors: Ronit Bustin, Kfar Saba (IL); Claudia V. Goldman-Shenhar, Mevasseret Zion (IL)

(73) Assignee: GM GLOBAL TECHNOLOGY OPERATIONS LLC, Detroit, MI (US)

(21) Appl. No.: 18/336,437

(22) Filed: Jun. 16, 2023

(51) Int. Cl. B60W 50/06; B60W 60/00; G06F 17/16

(52) U.S. Cl. CPC B60W 50/06; B60W 60/001; G06F 17/16

(57) ABSTRACT

A method of analyzing a decision for an automated system. The method includes receiving a vector having a length. A plurality of distribution vectors is created each having a length that matches the length of the vector. Divergence calculations are performed with the vector and each of the plurality of distribution vectors. A minimum output value determined by the divergence calculations is calculated. A minimizing distribution vector is identified from the plurality of distribution vectors that corresponds to the minimum output value from the divergence calculations. A conclusiveness of a decision is determined based on the vector in view of the minimizing distribution vector.

### INTRODUCTION

The subject disclosure relates to automatic decision making and, in particular, to a system and method for determining a greater understanding of automated decisions.

Artificial Intelligence (AI) can be used in an autonomous or semi-autonomous vehicle to determine an action for the vehicle to take. Automated systems routinely make decisions based on a vector that reflects system options for choices of behavior with entries that include values representing the desirability of choosing that behavior. Automated systems may make a final decision based on the vector by selecting an entry with the greatest value or a value above a predetermined threshold. However, these approaches fail to consider alternative actions.

### SUMMARY

Disclosed herein is a method of analyzing a decision for an automated system. The method includes receiving a vector having a length. A plurality of distribution vectors is created each having a length that matches the length of the vector. Divergence calculations are performed with the vector and each of the plurality of distribution vectors. A minimum output value determined by the divergence calculations is calculated. A minimizing distribution vector is identified from the plurality of distribution vectors that corresponds to the minimum output value from the divergence calculations. A conclusiveness of a decision is determined based on the vector in view of the minimizing distribution vector.

Another aspect of the disclosure may be where the divergence calculations include Jensen-Shannon divergence calculations, and the vector is received from an automated system.

Another aspect of the disclosure may include sorting the vector to create a sorted vector and performing the divergence calculations based on the sorted vector and each of the plurality of distribution vectors.

Another aspect of the disclosure may be where sorting the vector to create the sorted vector includes creating a permutation vector to determine an original order of entries in the vector.

Another aspect of the disclosure may include creating a conclusiveness vector from the minimizing distribution vector by applying the permutation vector to the minimizing distribution vector to associate the conclusiveness of the decision with at least one corresponding value in the vector.

Another aspect of the disclosure may include creating a conclusiveness vector from the minimizing distribution vector to associate the conclusiveness of the decision with at least one corresponding value in the vector.

Another aspect of the disclosure may be where determining the conclusiveness of the decision based on the minimizing distribution vector includes identifying at least one non-zero value in the minimizing distribution vector.

Another aspect of the disclosure may be where if the at least one non-zero value includes a quantity of non-zero values exceeding a predetermined threshold, then the conclusiveness of the decision is low.

Another aspect of the disclosure may be where if the at least one non-zero value includes a quantity of non-zero values below a predetermined threshold, then the conclusiveness of the decision is high.

Another aspect of the disclosure may be where each of the plurality of distribution vectors includes at least one non-zero value.

Another aspect of the disclosure may be where the at least one non-zero value in each of the plurality of distribution vectors is equal to the multiplicative inverse of a quantity of non-zero values in a corresponding one of the plurality of distribution vectors.

Another aspect of the disclosure may be where a quantity of vectors in the plurality of distribution vectors is less than or equal to a quantity of entries in the vector.

Another aspect of the disclosure may be where the divergence calculations include Jensen-Shannon divergence calculations, and the vector is received from an automated system.

Another aspect of the disclosure may be where each of the plurality of distribution vectors are filled with at least one non-zero distribution value in a left to right order.

Disclosed herein is a non-transitory computer-readable medium embodying programmed instructions which, when executed by a processor, are operable for performing a method. The method includes receiving a vector having a length. A plurality of distribution vectors is created each having a length that matches the length of the vector. Divergence calculations are performed with the vector and each of the plurality of distribution vectors. A minimum output value determined by the divergence calculations is calculated. A minimizing distribution vector is identified from the plurality of distribution vectors that corresponds to the minimum output value from the divergence calculations. A conclusiveness of a decision is determined based on the vector in view of the minimizing distribution vector.

Disclosed herein is a vehicular system. The system includes a plurality of sensors and a controller in communication with the plurality of sensors. The controller is configured to receive a vector having a length, create a plurality of distribution vectors each having a length that matches the length of the vector, and perform divergence calculations with the vector and each of the plurality of distribution vectors. The controller is also configured to identify a minimum output value determined by the divergence calculations and identify a minimizing distribution vector from the plurality of distribution vectors that corresponds to the minimum output value from the divergence calculations. The controller is further configured to determine a conclusiveness of a decision based on the vector in view of the minimizing distribution vector.

### DESCRIPTION OF THE DRAWINGS

FIG. 1 illustrates a vehicle that can be operated in an autonomous mode or automated mode, in accordance with an exemplary embodiment.

FIG. 2 illustrates a method of determining an action for an automated system.

FIG. 3 illustrates a method of analyzing a decision based on a vector generated from the automated system.

Some embodiments of the present disclosure are now described, by way of example only, and with reference to the accompanying drawings. The same reference number represents the same element or the same type of element on all drawings.

### DETAILED DESCRIPTION

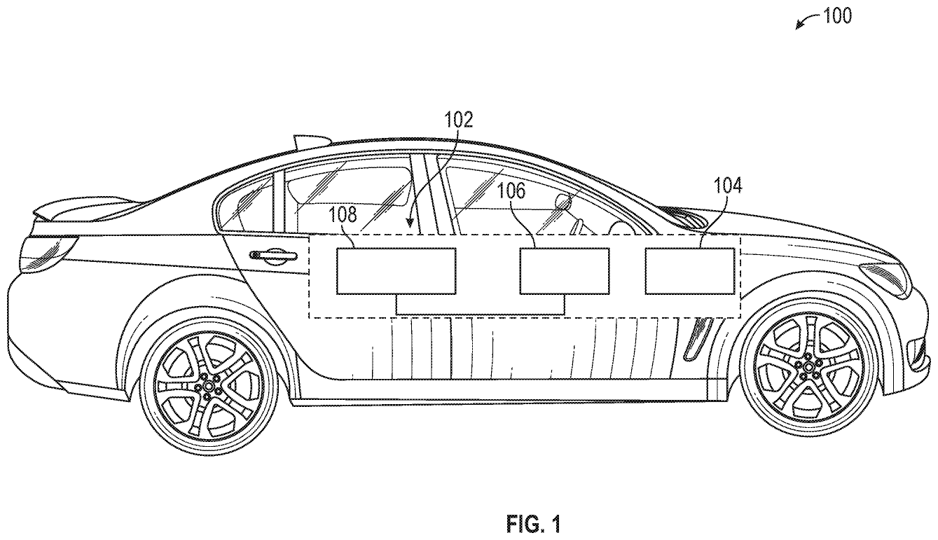

In accordance with an exemplary embodiment, FIG. 1 shows a vehicle 100 that can be operated in an autonomous mode or automated mode. The vehicle 100 can be a fully autonomous vehicle or a semi-autonomous vehicle. The vehicle 100 includes a driving system 102 that controls autonomous operation of the vehicle. The driving system 102 includes a sensor system 104 for obtaining information about the surrounding or environment of the vehicle 100, and a controller 106 for computing possible actions for the autonomous vehicle based on the obtained information and for implementing one or more of the possible actions, and a human machine interface 108 for explaining the actions taken by the vehicle to an occupant of the vehicle, such as a driver or passenger. The sensor system 104 can include devices such as cameras, Lidar, radar, GPS, etc.

The human machine interface 108 need not be dedicated to explaining actions and can be an interface that is used in the vehicle for purposes other than for explaining the actions. The human machine interface 108 can include one or more interfaces, such as a speaker, a display, a haptic device, etc. Each interface is suitable for a given modality of a message. For example, the speaker can be employed to present an aural message. The display can be employed to present a written message, graph, or animation. The haptic device can be employed to present tactile message, such as a vibration, that is felt by the occupant. In another embodiment, the human machine interface 108 can be a mobile device that can be used by the occupant either while inside the vehicle or outside the vehicle.

The controller 106 may include processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality. The controller 106 may include a non-transitory computer-readable medium that stores instructions which, when processed by one or more processors of the controller 106, implement a method of determining a soft understanding of automated decisions, according to one or more embodiments detailed herein. The controller 106 can operate programs that perform artificial intelligence. However, this disclosure applies to decision-making systems that utilizes or generates vectors, such as probability or confidence vectors, in the decision-making process.

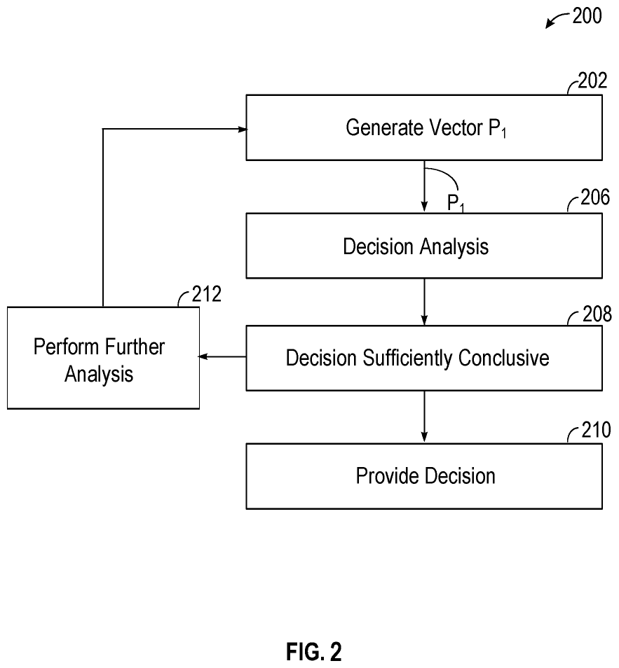

FIG. 2 illustrates a method 200 of operating an automated system, such as the driving system 102 for the vehicle 100, to determine a final decision based on a vector P₁. In accordance with an exemplary embodiment, the system 102 generates (Block 202) the vector P₁, such as a probability vector or a confidence vector, that reflects a current understanding of the system 102 in a decision-making process. The vector P₁ includes a plurality of entries and reaches the final decision by selecting one of the plurality of entries automatically from the vector P₁. These decisions are often reached as a consequence of hard thresholds applied on a soft conclusion (e.g., a probability vector or a confidence vector). Decisions that result from applying hard thresholds, commonly identified as hard decisions, usually select a maximum argument in the vector P₁ and return it as the decision for the automated system.

The method 200 analyzes the vector P₁ as part of decision analysis performed at Block 206 in the context of the solution process of the system 102 to determine a soft understanding of the system's reasoning process for selecting the final decision as opposed to making a hard decision. For example, with automated driving algorithms, such as a Monte Carlo Tree Search (MCTS), the vector P₁ is analyzed to determine the dominance of one of the decisions in the vector. The method 200 allows the system 102 to determine if the vector P₁ includes a single dominant action that it is considering executing, two competing actions, or maybe the method 200 did not determine a clear decision to be made from each of the different possibilities in the vector P₁.

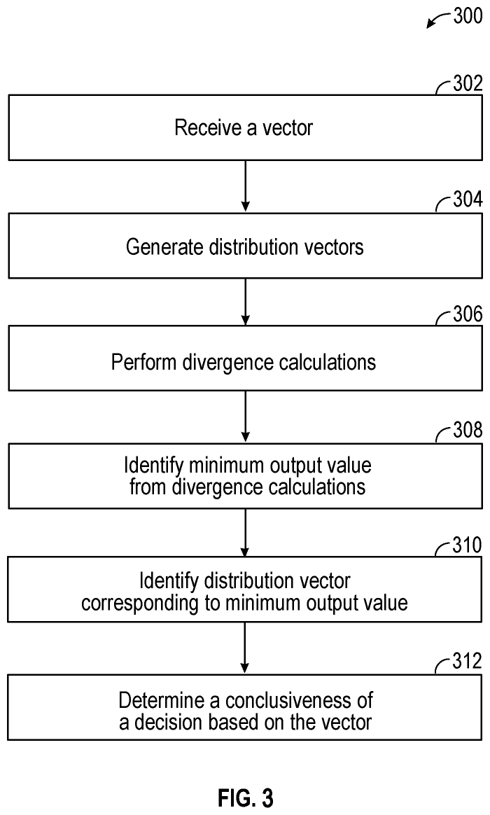

FIG. 3 illustrates an example method 300 of performing decision analysis on the vector P₁ in Block 206 of the method 200. The decision analysis performed at Block 206 can be utilized in different ways depending on the context of the system 102 and the end receiver of that decision (e.g., user or engineer).

The decision analysis performed by the method 300 includes divergence calculations based on the vector P₁ and a plurality of distribution vectors. The method 300 begins by receiving the vector P₁ from the system 102 (Block 302). The vector P₁ includes a plurality of entries each having a value that represents a decision to be made by the automated system. EQ. 1 below represents an example vector P₁ received at Block 302. Each value in the vector P₁ corresponds to a possible decision to be taken by the automated system. In the illustrated example, the values in the vector P₁ could correspond to the system 102 determining that the vehicle 100 should turn right, turn left, accelerate, decelerate, or make no change in action. Under a hard decision making approach, the system might select the action corresponding to the highest value, which would be “decelerate” in this example.

$${P}_{1} = ( 0.05 , 0.35 , 0.05 , 0.45 , 0.1 ) \qquad EQ . 1$$

In one example, the method 300 sorts the values in the vector P₁ in descending order to generate a sorted vector P_{1S} as shown in EQ. 2 below.

$${P}_{1 S} = ( 0.45 , 0.35 , 0.1 , 0.05 , 0 \text{.05} ) \qquad EQ . 2$$

The method 300 can also generate a permutation vector P_{1P} to maintain a record of the original order of values in the vector P₁ after the sorting. An example permutation vector PIP for mapping sorted vector P_{1S} onto the original vector P₁ is shown in EQ. 3 below.

$${P}_{1 P} = ( 4 , 2 , 5 , 1 , 3 ) \qquad EQ . 3$$

The method 300 then generates a plurality of distribution vectors at Block 304. In one example, the plurality of distribution vectors includes a first set of distribution vectors for performing the divergence calculations with the sorted vector P_{1S}. Each of the first set of distribution vectors Qⱼ (EQ. 4) has a length that matches a length of the vector P₁ being analyzed.

$${Q}_{j} = ( \frac{1}{j} , … , \frac{1}{j} , 0 , … 0 ) \qquad EQ . 4$$

In EQ. 4 above, j is a variable equal to a quantity of non-zero values in the distribution vector. For each non-zero value in a distribution vector, the non-zero value is equal to the multiplicative inverse of the quantity of non-zero values in the distribution vector. For example, with j equal to “1,” the equation for Q₁ would be represented as shown in EQ. 5 below. Also, the non-zero values fill the distribution vectors from left to right in the illustrated example for performing the divergence calculation.

$${Q}_{1} = ( \frac{1}{1} , 0 , 0 , 0 , 0 ) \qquad EQ . 5$$

This same approach is taken for generating the distribution vectors Q₂, Q₃, Q₄, and Q₅. For the distribution vector Q₅, the variable j is equal to 5 and Q₅ would be represented as shown in EQ. 6 below.

$${Q}_{5} = ( \frac{1}{5} , \frac{1}{5} , \frac{1}{5} , \frac{1}{5} , \frac{1}{5} ) \qquad EQ . 6$$

For the illustrated example with P₁ having five entries, the distribution vectors would be created for integer values of j from “1” to “5” such that the quantity of distribution vectors equals the quantity of entries in the vector P₁. The distribution vector Q₅ as shown in EQ. 6 also represents a uniform distribution vector for the actions and the distribution vector Q₁ represents the greatest level of conclusiveness possible for a decision based on the vector P₁ as will be discussed in greater detail below.

Once the vectors have been generated, the method 300 performs a divergence calculation at Block 306. The divergence calculation can be performed between the sorted vector P_{1S} and the distribution vectors Q₁-Q_{N}. In one example, the divergence calculation performed is a Jensen-Shannon divergence calculation as shown in EQ. 7 below. The divergence calculation provides an output value representing a measurement of a distance between two data distributions showing how different the two distributions are from each other.

$$J S D ( P ‖ Q ) = \frac{1}{2} D ( P ‖ M ) + \frac{1}{2} D ( Q ‖ M ) \qquad EQ . 7$$

The variable M in EQ. 7 above is shown in EQ. 8 below.

$$M = \frac{1}{2} ( P + Q ) \qquad EQ . 8$$

As the method 300 performs the divergence calculations with the first set of distribution vectors and the sorted vector P_{1S}, the method 300 identifies a minimum output value from those calculations (Block 308). The method 300 can then identify the distribution vector that corresponded to the minimum output value (Block 310).

Alternatively, the distribution vectors, Q₁, . . . , Q_{N} can be analyzed in an order that corresponds to an increasing value of j. The method 300 can identify which of the distribution vector Q₁, Q₂, Q₃, Q₄, or Q₅ corresponds to a minimum output value from the divergence calculations based on the comparison with the vector P_{1S}. Furthermore, a local minimum output value can be determined by selecting the previous distribution vector when an output value of the convergence calculations has increased from a previous output value calculated. This will provide a reduction in computing resources needed in some instances for performing the divergence calculations if the distribution vector associated with the local minimum output value is identified prior to performing the divergence calculations on the remaining distribution vectors. Also, the distribution vector associated with the minimum output value can be identified as a minimizing distribution vector because it results in a minimum output value for the divergence calculations.

The method 300 utilizes the minimizing distribution vector to determine a conclusiveness of the final decision based on the vector P₁, for the system 102. One feature of identifying the minimum output value from the divergence calculation is that it identifies the distribution vector with the most similar distribution. Therefore, the method 300 allows the system 102 to consider more possible actions from the vector P₁, that would have been eliminated under a hard decision making approach.

The conclusiveness of an action based on the vector P₁ can be determined by identifying a quantity of non-zero values in the minimizing distribution vector (Block 312). When the quantity of non-zero values exceed a predetermined threshold, then the conclusiveness of a decision based on the vector P₁ is low. For example, if the quantity of non-zero numbers in the minimizing distribution vector is equal to a total quantity of entries in the distribution vector, then each of the possible actions based on the vector P₁ would have a similar level of conclusiveness. This is because the minimizing distribution vector matches a distribution of a uniform probability vector.

However, when a quantity of non-zero values in the minimizing distribution vector is below a predetermined threshold, then the conclusiveness of a decision based on the vector P₁ is high. For example, if the quantity of non-zero numbers in the minimizing distribution vector is equal to one, then the automated system has the highest level of conclusiveness possible to select that entry as a final decision for the system 102.

Furthermore, if the minimizing distribution vector includes multiple non-zero values that are below the predetermined threshold, the automated system can know with a high degree of certainty that the decisions corresponding to those values should be considered while the remaining decisions can be disregarded. The system 102 can also communicate the decisions being considered through the human machine interface 108 for explaining the actions taken by the vehicle 100 to an occupant, such as a driver or passenger, or even as a request for the driver to intervene.

The method 300 can determine which values of the vector P₁ should be considered with a soft understanding by matching at least one non-zero value in the minimizing distribution vector to at least one corresponding value in the vector P₁. Those values correspond to the soft decision values that should be considered by the automated system that could be disregarding under a hard decision-making process. When the sorted vector P_{1S} was used in the divergence calculations, the method 300 utilizes the permutation vector P_{1P} to map the non-zero values in the minimizing divergence vector to a corresponding entry in the vector P₁.

The method 300 can also create a conclusiveness vector from the minimizing distribution vector. The conclusiveness vector indicates significant choices from the vector P₁ that should be considered beyond making a hard decision on the vector P₁. The conclusiveness vector matches a length of the vector P₁ returns a value of “1” for each entry location corresponding to a non-zero value in the minimizing distribution vector. When the sorted vector P_{1S} was used in the divergence calculations, the method 300 utilizes the permutation vector PIP to map the values in the minimizing divergence vector to a corresponding entry in the vector P₁.

With the conclusiveness vector or the minimizing distribution vector generated as described in the method 300 above, the method 200 determines if a decision based on the vector P₁ is sufficiently conclusive in view of either the conclusiveness vector or the minimizing distribution vector at Block 208. If either of these vectors are sufficiently conclusive, then the method 200 will proceed to Block 210 to provide a final decision. If these vectors are not sufficiently conclusive, then the method 200 can perform further analysis at Block 212 before returning to the system 102 to generate a new vector at Block 202. The system 102 can then produce another vector to be analyzed by the method 200 to determine if a decision based on that vector would be sufficiently conclusive to render a final decision. This allows the method 200 to incorporate an additional layer of reconsideration to the next action of the planning algorithm, request additional information, or rerun the decision-making algorithm on the system 102.

While various embodiments have been described, the description is intended to be exemplary rather than limiting. It will be apparent to those of ordinary skill in the art that many more embodiments and implementations are possible that are within the scope of the embodiments. Any feature of any embodiment may be used in combination with or substituted for any other feature or element in any other embodiment unless specifically restricted. Accordingly, the embodiments are not to be restricted except in light of the attached claims and their equivalents. Also, various modifications and changes may be made within the scope of the attached claims.

What is claimed is:

1. A method of analyzing a decision for an automated system, the method comprising:
receiving a vector having a length;
creating a plurality of distribution vectors each having a length that matches the length of the vector;
performing divergence calculations with the vector and each of the plurality of distribution vectors;
identifying a minimum output value determined by the divergence calculations;
identifying a minimizing distribution vector from the plurality of distribution vectors that corresponds to the minimum output value from the divergence calculations; and
determining a conclusiveness of a decision based on the vector in view of the minimizing distribution vector.

2. The method of claim 1, wherein the divergence calculations include Jensen-Shannon divergence calculations, and the vector is received from an automated system.

3. The method of claim 1, including sorting the vector to create a sorted vector and performing the divergence calculations based on the sorted vector and each of the plurality of distribution vectors.

4. The method of claim 3, wherein sorting the vector to create the sorted vector includes creating a permutation vector to determine an original order of entries in the vector.

5. The method of claim 4, including creating a conclusiveness vector from the minimizing distribution vector by applying the permutation vector to the minimizing distribution vector to associate the conclusiveness of the decision with at least one corresponding value in the vector.

6. The method of claim 1, including creating a conclusiveness vector from the minimizing distribution vector to associate the conclusiveness of the decision with at least one corresponding value in the vector.

7. The method of claim 1, wherein determining the conclusiveness of the decision based on the minimizing distribution vector includes identifying at least one non-zero value in the minimizing distribution vector.

8. The method of claim 7, wherein if the at least one non-zero value includes a quantity of non-zero values exceeding a predetermined threshold, then the conclusiveness of the decision is low.

9. The method of claim 7, wherein if the at least one non-zero value includes a quantity of non-zero values below a predetermined threshold, then the conclusiveness of the decision is high.

10. The method of claim 1, wherein each of the plurality of distribution vectors includes at least one non-zero value.

11. The method of claim 10, wherein the at least one non-zero value in each of the plurality of distribution vectors is equal to the multiplicative inverse of a quantity of non-zero values in a corresponding one of the plurality of distribution vectors.

12. The method of claim 11, wherein a quantity of vectors in the plurality of distribution vectors is less than or equal to a quantity of entries in the vector.

13. The method of claim 12, wherein the divergence calculations include Jensen-Shannon divergence calculations, and the vector is received from an automated system.

14. The method of claim 10, wherein each of the plurality of distribution vectors are filled with at least one non-zero distribution value in a left to right order.

15. A non-transitory computer-readable medium embodying programmed instructions which, when executed by a processor, are operable for performing a method comprising:
receiving a vector having a length;
creating a plurality of distribution vectors each having a length that matches the length of the vector;
performing divergence calculations with the vector and each of the plurality of distribution vectors;
identifying a minimum output value determined by the divergence calculations;
identifying a minimizing distribution vector from the plurality of distribution vectors that corresponds to the minimum output value from the divergence calculations; and
determining a conclusiveness of a decision based on the vector in view of the minimizing distribution vector.

16. The computer-readable medium of claim 15, wherein the divergence calculations include Jensen-Shannon divergence calculations.

17. The computer-readable medium of claim 15, including sorting the vector to create a sorted vector and performing the divergence calculations based on the sorted vector and each of the plurality of distribution vectors.

18. The computer-readable medium of claim 15, including creating a conclusiveness vector from the minimizing distribution vector to associate the conclusiveness of the decision with at least one corresponding value in the vector.

19. The computer-readable medium of claim 15, wherein determining the conclusiveness of the decision based on the minimizing distribution vector includes identifying at least one non-zero value in the minimizing distribution vector.

20. A vehicular system comprising:
a plurality of sensors; and
a controller in communication with the plurality of sensors and configured to:
receive a vector having a length;
create a plurality of distribution vectors each having a length that matches the length of the vector;
perform divergence calculations with the vector and each of the plurality of distribution vectors;
identify a minimum output value determined by the divergence calculations;
identify a minimizing distribution vector from the plurality of distribution vectors that corresponds to the minimum output value from the divergence calculations; and
determine a conclusiveness of a decision based on the vector in view of the minimizing distribution vector.
